(19) United States
(12) Patent Application Publication
(10) Pub. No.: US 2015/0306628 A1
(43) Pub. Date: Oct. 29, 2015

(54) METHOD FOR MANUFACTURING COMPOUND DIAPHRAGM

(71) Applicant: Bingke Zhu, Shenzhen (CN)

(72) Inventor: Bingke Zhu, Shenzhen (CN)

(73) Assignee: AAC TECHNOLOGIES PTE. LTD., Singapore city (SG)

(21) Appl. No.: 14/522,700

(22) Filed: Oct. 24, 2014

(30) Foreign Application Priority Data
Apr. 25, 2014 (CN) 201410172528.7

(51) Int. Cl. B05D 3/00; G10K 13/00

(52) U.S. Cl. CPC B05D 3/007; G10K 13/00

(57) ABSTRACT

The present disclosure provides a method for manufacturing a compound diaphragm. The method comprises the following steps: providing a sheet made of macromolecular material; providing damping glue; blending powdered graphene into the damping glue; and coating the damping glue blended with the graphene onto a surface of the sheet made of macromolecular material to form a compound diaphragm. The method is simple, has a low production cost, and can provide a compound diaphragm with high strength and superior performances.

### FIELD OF THE INVENTION

The present disclosure relates to a method for manufacturing a compound diaphragm.

### DESCRIPTION OF RELATED ART

As being propelled by the increasingly heightened requirements on mobile phones in the market, the mobile phones. The mobile phones trends to be designed with low profile and better sound quality. For meeting this trend or requirement, acoustic component used in the mobile phones should also be designed to have small size, and high sound quality.

Diaphragms are core components of an acoustic component, so the demand for acoustic performances of the diaphragms becomes also higher correspondingly.

The diaphragms in the related art are formed of a single cloth diaphragm or other materials, which can be hot-press molded, through a pressing process. However, the diaphragms of this structure tend to produce the split vibration (unbalanced vibration) due to the insufficient stiffness of the diaphragms, and this leads to distortion and badly affects the hearing experience. Additionally, in practical applications, in order to enhance the strength of the diaphragms without affecting the sound quality, a common practice in the art is to increase the thickness of partial areas of the diaphragms. However, the diaphragms formed of a single material have the same thickness throughout the diaphragms once being produced, so they cannot satisfy the aforesaid need.

Accordingly, the present disclosure provides a novel compound diaphragm to overcome the aforesaid shortcomings.

### BRIEF DESCRIPTION OF THE DRAWINGS

FIG. 1 is a flowchart view of a process for manufacturing a compound diaphragm of the present disclosure.

### DETAILED DESCRIPTION OF EMBODIMENT OF THE INVENTION

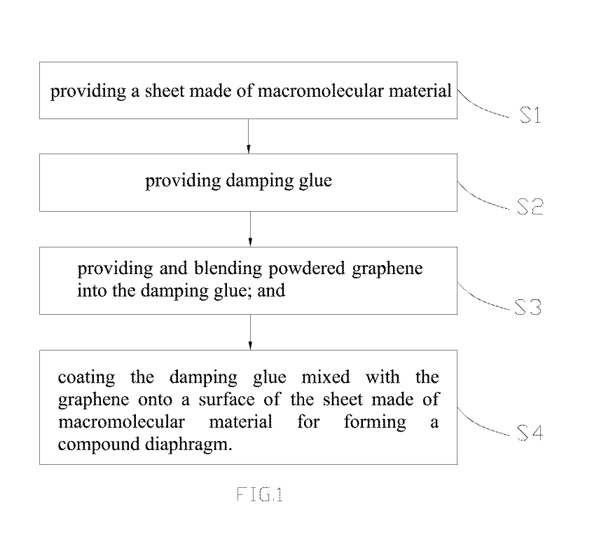

Hereinbelow, a method for manufacturing a compound diaphragm of the present disclosure will be described in detail. Referring to FIG. 1, a manufacturing method for manufacturing a compound diaphragm comprises the following steps:

Step 1: providing a sheet made of macromolecular material;

Step 2: providing damping glue;

Step 3: providing and blending powdered graphene into the damping glue; and

Step 4: coating the damping glue blended with the graphene onto a surface of the sheet made of macromolecular material for forming a compound diaphragm.

In this embodiment, the damping glue provided in Step 2 is in a liquid state. Powdered graphene is blended into the damping glue, the mixture is fully mixed, and then the damping glue having the graphene blended therein is coated on the surface of the sheet made of macromolecular material to form the compound diaphragm.

Compared with the related compound diaphragm, instead of attaching a number of layers of diaphragms together, the graphene is blended into the damping glue and then the mixture is coated on the surface of the macromolecular diaphragm. The compound diaphragm thus formed presents better homogeneity and stability, and the whole vibrating diaphragm has consistent performances throughout the diaphragm, so the split vibration is prevented. Additionally, the compound diaphragm of the present disclosure also features high strength and large stiffness, which effectively improves the acoustic effect of the diaphragm.

In the present disclosure, the macromolecular material may be any of polyetheretherketone (PEEK), polyethylene naphthalate (PEN), polyethylene terephthalate (PET), polyphenylene sulfide (PPS) and polyarylate (PAR).

Most preferably, PEEK is used because it features a high elasticity modulus and high abrasive resistance. Use of PEEK can enhance the strength and stiffness and improve the acoustic performances of the compound diaphragm.

The described method for a compound diaphragm of the present disclosure is simple, has a low production cost, and can provide a compound diaphragm with high strength and superior performances, and as compared to the conventional compound diaphragms, the compound diaphragm prepared by this method is more robust, stable and reliable. The compound diaphragm prepared by this method can be used in electroacoustic devices such as loud speakers and sound receivers.

While the present invention has been described with reference to the specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A method for manufacturing a compound diaphragm, comprising the steps of:
Step 1: providing a sheet made of macromolecular material;
Step 2: providing damping glue;
Step 3: providing and blending powdered graphene into the damping glue; and
Step 4: coating the damping glue mixed with the graphene onto a surface of the sheet made of macromolecular material for forming a compound diaphragm.

2. The method for manufacturing a compound diaphragm of claim 1, further comprising the step of drying the compound diaphragm.

3. The method for manufacturing a compound diaphragm of claim 1, wherein the material of the macromolecular diaphragm is any of polyetheretherketone (PEEK), polyethylene naphthalate (PEN), polyethylene terephthalate (PET), polyphenylene sulfide (PPS) and polyarylate (PAR).
